(19) United States
(12) Patent Application Publication
(10) Pub. No.: US 2022/0222277 A1
(43) Pub. Date: Jul. 14, 2022

(54) SYSTEM AND METHOD FOR DATA PROFILING

(71) Applicant: TEALBOOK INC., Toronto (CA)

(72) Inventors: Srikanth PASUMARTHY, Toronto (CA); Michael LIU, Toronto (CA); Jervis PINTO, Toronto (CA); Merron WOODBURY, Toronto (CA); Ian WOODBURY, Toronto (CA); Geoffrey PEDDLE, Toronto (CA)

(21) Appl. No.: 17/573,904

(22) Filed: Jan. 12, 2022

Related U.S. Application Data
(60) Provisional application No. 63/136,398, filed on Jan. 12, 2021.

(51) Int. Cl. G06F 16/28; G06F 16/955

(52) U.S. Cl. CPC G06F 16/285; G06F 16/9558

(57) ABSTRACT

Disclosed are systems and methods for profiling a plurality of companies. The companies are profiled by receiving HTML files on the world wide web that contain hyperlinks to a domain name of one or more of the plurality of companies; determining an ingress of each of the plurality of companies based on a number of hyperlinks to the domain name of that company in the HTML files; receiving industry categories and industry embedding values for each of the plurality of companies; and designating a first company and a second company of the plurality of companies as similar based at least in part on one or more of the ingress of the first company, the ingress of the second company, a semantic distance between the industry embedding values of the first company and the industry embedding values of the second company, and a number of industry categories common between the first company and the second company.

### CROSS-REFERENCE TO RELATED APPLICATIONS

This application claims all benefit, including priority of U.S. Provisional Patent Application No. 63/136,398, filed Jan. 12, 2021, the entire contents of which are incorporated herein by reference.

### FIELD

The disclosure relates to data profiling techniques, in particular, profiling of companies such as suppliers to determine supplier information and insights.

### BACKGROUND

Many companies have an online web presence, such as a company website or other online source, containing information relating to that company's profile, including bibliographic information, such as company name, address, and phone number, and industry information relating to the company's business. However, information accessed from the world wide web is often presented in a highly unstructured data format from which it is difficult to parse details, such as information that would be relevant in a traditional procurement process between a buyer and the company as a supplier.

### SUMMARY

According to an aspect, there is provided a computer-implemented method for profiling a plurality of companies. The method includes receiving HTML files on the world wide web that contain hyperlinks to a domain name of one or more of the plurality of companies; determining an ingress of each of the plurality of companies based on a number of hyperlinks to the domain name of that company in the HTML files; receiving industry categories and industry embedding values for each of the plurality of companies; and designating a first company and a second company of the plurality of companies as similar based at least in part on one or more of the ingress of the first company, the ingress of the second company, a semantic distance between the industry embedding values of the first company and the industry embedding values of the second company, and a number of industry categories common between the first company and the second company.

In some embodiments, the method also includes identifying URLs of the HTML files.

In some embodiments, the method also includes generating a webgraph linking the URLs with the domains.

In some embodiments, the method also includes determining a number of shared backlinks between the first company and the second company based on the webgraph.

In some embodiments, the ingress is determined using the webgraph.

In some embodiments, the industry categories comprise two-digit industry categories and four-digit industry categories.

In some embodiments, the first company and the second company are designated as similar based at least in part on a percentage of the number of common four-digit industry categories as compared to a total number of four-digit industry categories associated with the first company and the second company.

In some embodiments, the first company and the second company are designated as similar based at least in part on a localized semantic distance between the number of shared backlinks, the ingress of the first company, the ingress of the second company, and the number industry categories common between the first company and the second company.

In some embodiments, the first company and the second company are designated as similar when the localized semantic distance is less than a predefined hyperparameter value.

In some embodiments, the industry categories comprise two-digit industry categories and four-digit industry categories, and for each of the companies are determined by: receiving keywords extracted from a website associated with the company; inputting the keywords to a two-digit category classifier, the two-digit category classifier including a pre-final dense layer for generating industry embedding values; classifying, at an output layer of the two-digit category classifier, the probability of the keywords being in one or more two-digit industry categories; identifying two-digit industry categories for which the probability meets a threshold; inputting the industry embedding values to a plurality of four-digit category classifiers, each of the four-digit category classifiers a binary classifier for a four-digit industry category; and for each of the four-digit category classifiers, classifying the probability of the keywords being in that four-digit industry category.

In some embodiments, the two-digit code classifier is a multi-label BERT classifier.

In some embodiments, the four-digit code classifiers comprise XGBoost binary classifiers.

In some embodiments, the keywords are extracted from the website by: extracting visible sentences from the website; classifying the visible sentences as selected sentences; extracting candidate phrases from the website; and for each of the candidate phrases: matching the candidate phrase to a vocabulary dictionary to generate a vocabulary score; matching the candidate phrase to a stopwords dictionary to generate a stopwords score; selecting a similarity threshold value for the candidate phrase based at least in part on a source of the candidate phrase, the vocabulary score and the stopwords score; and comparing the candidate phrase to the selected visible sentences to determine a similarity value, and when the similarity value is above the threshold similarity value, designating the candidate phrase as one or more of the keywords.

In some embodiments, the candidate phrases are noun phrases.

In some embodiments, the candidate phrases are extracted from metadata of the website.

In some embodiments, the candidate phrases are extracted from one or more of htags, meta tags, ptags and title tags of the website.

According to another aspect, there is provided a computer-implemented system for profiling a plurality of companies. The system includes: at least one processor; memory in communication with the at least one processor; and software code stored in the memory. The software code, when executed at the at least one processor, causes the system to: receive HTML files on the world wide web that contain hyperlinks to a domain name of one or more of the plurality of companies; determine an ingress of each of the plurality of companies based on a number of hyperlinks to the domain name of that company in the HTML files; receive industry categories and industry embedding values for each of the plurality of companies; and designate a first company and a second company of the plurality of companies as similar based at least in part on one or more of the ingress of the first company, the ingress of the second company, a semantic distance between the industry embedding values of the first company and the industry embedding values of the second company, and a number of industry categories common between the first company and the second company.

According to a further aspect, there is provided a non-transitory computer-readable medium having computer executable instructions stored thereon for execution by one or more computing devices, that when executed perform a method as disclosed herein.

Other features will become apparent from the drawings in conjunction with the following description.

### BRIEF DESCRIPTION OF DRAWINGS

In the figures which illustrate example embodiments,

FIG. 1 is a schematic diagram of a system for data profiling, according to an embodiment;

FIG. 2 is a schematic diagram of a company identifier, according to an embodiment;

FIG. 3 is a flow chart of an inference pipeline for keyword extraction, according to an embodiment;

FIG. 4 illustrates a table summarizing negative training data that can be obtained for URL classifiers, according to an embodiment;

FIG. 5A is a schematic diagram of an implementation of a matcher, according to an embodiment;

FIG. 5B is a data record, according to an embodiment;

FIG. 6 is a schematic diagram of a company classifier, according to an embodiment;

FIG. 7A illustrates an example hierarchical structure of industry classification codes, according to an embodiment;

FIG. 7B illustrates an implementation of a two-digit code classifier and four-digit code classifiers to an example hierarchy structure of industry classification codes, according to an embodiment;

FIG. 8A and FIG. 8B each illustrate a density plot for a distribution of training data across categories, according to an embodiment;

FIG. 9 illustrates a schematic of a similarity scorer, according to an embodiment;

FIG. 10 illustrates a graph of relationships between URLs and domain names, according to an embodiment;

FIG. 11 is a graph illustrating a distribution of number of suppliers that share backlinks, according to an embodiment;

FIG. 12 is a table outlining features, labels, and rules of models for determining similarity between companies, according to an embodiment;

FIG. 13 is a flow chart of a method for data profiling, according to an embodiment; and

FIG. 14 is a block diagram of example hardware components of a computing device for data profiling, according to an embodiment.

### DETAILED DESCRIPTION

The following disclosure describes a system and method for data profiling, in particular, determining supplier information and analyzing the data to glean insights.

Embodiments as disclosed herein may extract, process and manage data from online sources such as websites, which is often in a highly unstructured data format and that may not be consistent. Data can be processed to generate company data records and be stored in a suitable database for convenient access and in a suitable structured format.

Conveniently, with such a database of company data, analytics can be performed and insights gleaned, such as identifying companies as suppliers in a procurement process.

Embodiments of the system and method for data profiling may be useful in establishing and maintaining a buyer and supplier relationship.

In a possible implementation of embodiments disclosed herein, a use case is a buyer identifying companies as new suppliers. Keywords for a company that have been identified by embodiments of a keyword extractor, as disclosed herein, can be searched (for example, as features of data records stored in a database) to identify relevant companies to find suppliers that use those search terms. Similarly, NAICS codes identified using embodiments of a company classifier, as disclosed herein, can be searched when searching for a desired industry. Embodiments of a similarity scorer, as disclosed herein, may further be used to identify similar companies.

In another implementation, embodiments disclosed herein may be used to generate extensive or enriched data records about a company by associating features such as addresses, email contacts, phone numbers, products provided by supplier, and the like, with a company's data record. Such data records are accessible and can provide additional features about a company.

Aspects of various embodiments are described through reference to the drawings.

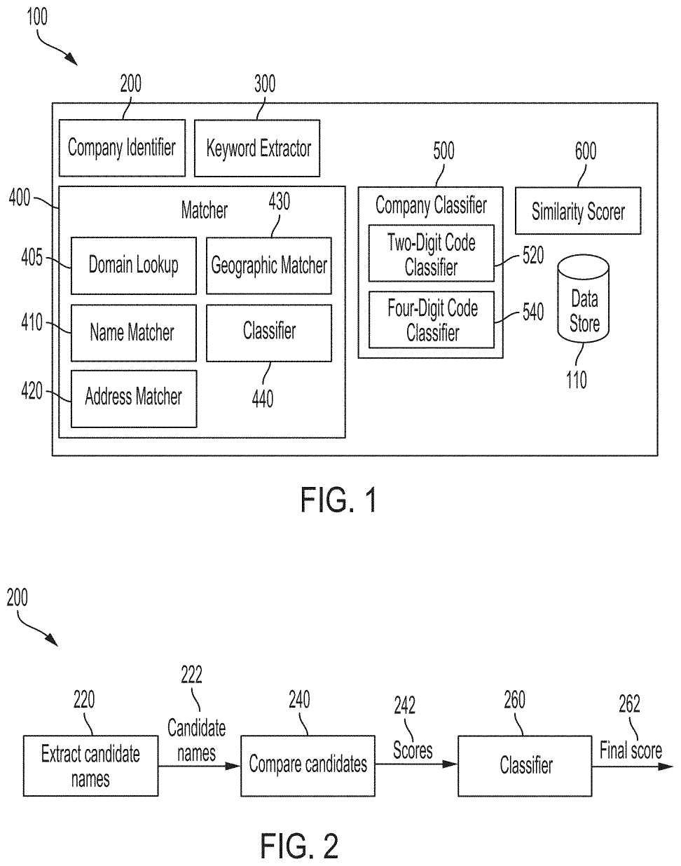

FIG. 1 is a schematic diagram of a system 100 for data profiling, according to an embodiment.

As shown in FIG. 1, system 100 can include a company identifier 200 for extracting a company name from a website, a keyword extractor 300 for extracting keywords from a website, a matcher 400 for associating features with a company profile, a company classifier 500 for classifying a company by industry codes, a similarity scorer 600 for identifying similar companies, and a data store 110 for storing data such as data records for companies.

Company names extracted by company identifier 200 and other keywords 342 extracted by keyword extractor 300 may be used by matcher 400 to form a company profile, stored for example as a data record in data store 110.

Keywords 342 extracted by keyword extractor 300 may also be input to company classifier 500 to determine two-digit industry codes and four-digit industry codes for a company. Embeddings of classifier 500 can be input to similarity scorer 600 to identify similar companies.

Hyperparameters of various components of system 100 may be tuned based on performance of downstream tasks, in an example, using a discrete optimization approach such as reinforcement learning.

Any of the techniques disclosed herein may be performed on a regular basis, as data, particularly on the world wide web, may continually be changing.

Company name identifier 200 can be configured to extract a company name from a website, and can thus link a company name and URL or domain.

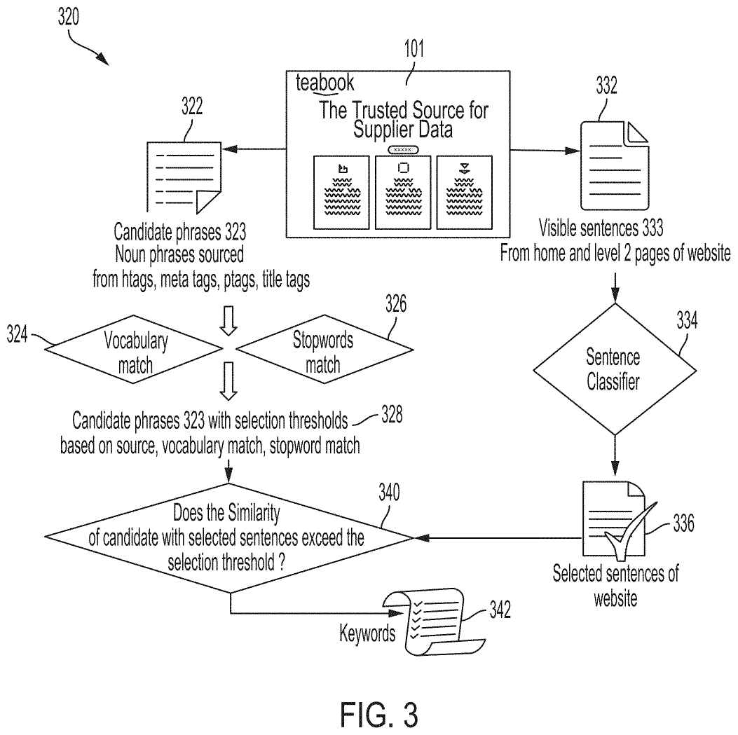

FIG. 2 illustrates company identifier 200, which at block 220 extracts candidate names 222 from a website, at block 240 compares candidate names 222 and generates scores 242 input to classifiers 260 to generate a final score 262.

A company name can be selected having the highest final score 262, or in an example, over a threshold. The company name can be used as input for matcher 300, discussed in further detail below.

As web data has a lot of variation and is only semi-structured, it can be challenging to reliably get the name of the company, what should seem like an obvious piece of data, from the website.

A company name can appear in a variety of places on a website, and candidate names 222 can be obtained, for example, from the following sources:
Various HTML elements (some examples below)
   <title>
   <meta property=“og:site_name” . . . >
   <link rel=“alternate” . . . >
Social media links
   Facebook
   Twitter
   LinkedIn
General text content
   Copyright text
   Capitalized Phrases
The domain name itself

Even when the company name is present, cleaning is often necessary to isolate the name from extraneous text.

For example, a copyright line could contain the name “Tealbook” mixed with other text: “Copyright © 2020 Tealbook|Powered by Tealbook”.

In the case of the domain name, the domain name may be parsed by looking for breaks according to existing vocabulary found on the webpage. For example, the domain “davidsonandrey.com” could be parsed as “David Son And Rey”, such as if those words are found in text elsewhere on the website. However, if the words “Davidson” and “Andrey” had been found elsewhere on the website, the domain could be parsed as “Davidson Andrey” instead (in an example, taking the longest possible string match). This can be done from both directions (e.g., going backwards in the string as well).

Company name identifier 200 can extract from a website a number of candidate names 222 for the name of the company, for example, from the sources listed above. Each candidate name 222 can be compared to every other candidate name 222 to get a set of scores 242. Scores 242 can be determined based on how close a candidate name 222 is to another candidate name 222, in an example, using various fuzzy matching algorithms or other suitable comparison technique.

One or more classifiers 260, trained on manually-labeled training data, can take in the scores 242 to give a final score 262 (for example, from an ensemble of three classifiers) for how likely the candidate name 222 is indeed the name of the company. Since a correct name of the company may appear in multiple contexts and the candidate name(s) 222 that appear the most can thus be designated as the correct name of the company.

In some embodiments, classifiers 260 can be one or more random forest, XGBoost, regression model, or other suitable classifier.

In some embodiments, an order of preference may be used. For example, if a name is found within the copyright text, and it is corroborated by being found in a Facebook candidate and the domain name itself, then it is used preferentially even if it may have a slightly lower score 262 coming from classifiers 260.

In some embodiments, some preprocessing can be performed on candidate names 222 such as removal of extraneous terms, for example, legal terms such as “Inc.” or “Corporation”, which may improve the performance of company name identifier 200, and the extraneous terms later reintroduced in a final identification of a company name.

Conveniently, advantages of embodiments of company identifier 200 as disclosed herein include robustness and resiliency. For example, even if one or some of the candidate names 222 are wrong or missing, it is still possible to get a correct answer for a company name.

In some embodiments, candidate names 222 can be obtained from other sources that have a good chance of yielding a correct name, which may improve performance of company identifier 200. Such sources include:
Logo image alternate text
Logo image itself (using OCR to extract the text)
Using Question Answering model (e.g. BERT-like model fine-tuned for QA tasks) to get a candidate name from the text

Keyword extractor 300 can be configured to extract keywords relating to a company from a website, for example, keywords that may be relevant in characterizing or describing the company.

Keyword extractor 300 can execute an inference pipeline 320. In some embodiments, an inference pipeline includes a sequence of procedures, rules, and machine learning (ML) algorithms that run on a webpage to extract the keywords that are identified as representing relevant “information” related to a company.

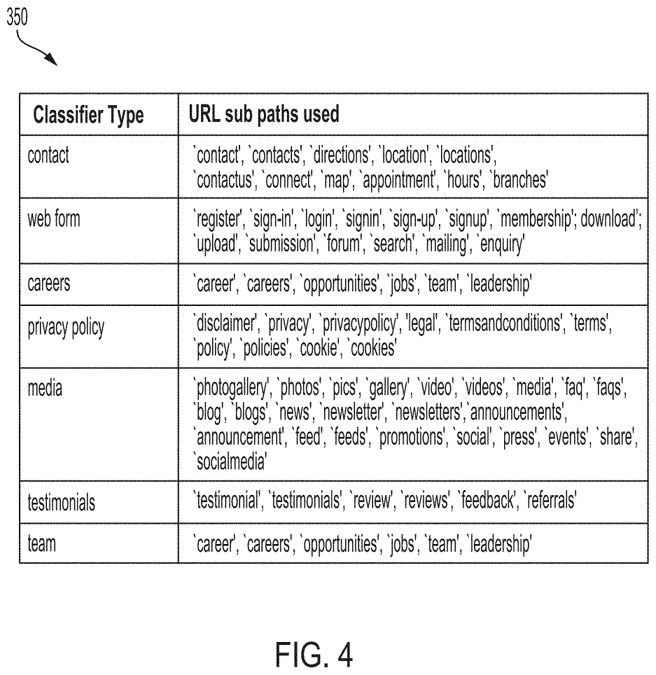

A schematic of inference pipeline 320 is illustrated in FIG. 3, according to an embodiment. As shown in FIG. 3, inference pipeline 320 can extract candidate phrases 323 from a website 101, perform vocabulary match 324 and stopwords match 326 to determine a score used as a selection threshold for each candidate phrase 323. Inference pipeline 320 also extracts visible sentences 333 that are classified by sentence classifier 334 and certain of visible sentences 333 selected as selected sentences 336. At block 340, keyword extractor 300 evaluates whether the similarity of a candidate phrase 323 with selected sentences 336 exceed the selection threshold for that candidate phrase 323, and if so, the candidate phrase 323 is designated as a keyword 342.

Inference pipeline 320 extracts keywords from text on a page of a business or company's website 101, in an example, a supplier's website, that represents the business in terms of products and solutions, referred to as “signal text”.

A website may not describe a business in direct way, and instead may include text describing the company's team members, location, instructions, phrases like “exceptional service”, referred to as “noise text”.

At block 322, keyword extractor 300 sources candidate phrases 323, which can include noun phrases, from content and metadata of website 101 including HTML fields, such as text that is tagged using anchor tags, htags, meta tags, ptags, and title tags. Anchor tag text can be tagged, for example, as <a>anchor tag</a>; meta tag text can be tagged, for example, as <meta content=keywords>meta tag</>; htag text can be tagged, for example, as <h{1,5}>htag</h{1,5}>; title tag text can be tagged, for example, as <title>title</title> (for text that is visible when the webpage tab is hovered in a browser); and p tag text can be tagged, for example, as <p>ptag</p> and can also include any visible text on a webpage of website 101.

A candidate phrase 323 can be a noun phrase, defined as a group of words where typically there is a noun and few attributes associated with it.

Candidate phrases 323 can be a super set containing all candidates, from which keywords 342 are designated.

In some embodiments, all text available on website 101 may be scraped, and from more than one webpage. In an example, every page of the domain for website 101 may be scraped.

In some embodiments, pages under a domain can be identified by pages that link from a home page, and all links under the same domain linked from every subsequent page.

At block 324 vocabulary matching may be performed on candidate phrases 323 against a vocabulary dictionary or list. The phrases of a vocabulary list can include drug names, names of products, and may typically include nouns. If a candidate phrase 323 matches a phrase from the vocabulary list, which may indicate a useful keyword and thus scored higher.

A vocabulary dictionary or list may catch more good keyword candidates which would normally be rejected for being out-of-vocabulary. In some embodiments, the vocabulary dictionary can be a file of a compiled a set of phrases, product names, chemical names, etc., that could be used to match keyword candidate phrases. The sources for the vocabulary phrases can include the UNSPSC code set, NDC approved drugs, the Common Procurement Vocabulary taxonomy and much more. In some embodiments, a vocabulary can have a size of 600,000 words and/or phrases from varied sources.

Vocabulary matching may be done by way of lookup, or alternatively, may be a semantic matching. In an example, each candidate phrase 323 may be mapped into a vector representation, and similarly each phrase in the vocabulary dictionary is also mapped to vector representation and a cosine similarity is measured between them.

Vocabulary matching can be done based on embedding similarity of candidate phrase 323 with each of the pre-built vocabulary words.

Vocabulary match 324 generates a vocabulary match score for each candidate phrase 323 based on a similarity to the vocabulary dictionary.

At block 326 stopword matching may be performed on noun phrases 323 against a stopwords dictionary or list, in an example, including 5,000 words and/or phrases such as “signup,” “login”, “contact us”, and the like. Stopwords may be less useful keywords, and thus scored lower.

While a strong vocabulary file match 324 can increase the chances of candidate phrase 323 to be selected as keyword, a stopwords match 326 can reduce the chance to be selected as keyword.

The stopwords dictionary can be a file that is a combination of two files where one is a list of names of people, cities, countries, job titles, and the like, where exact lookup of candidate phrase 323 is used. The second file can be a composition of commonly occurring noun phrases across NAICS categories such as “quick links”, “further information” where a cosine similarity of candidate phrase 323 can be computed to match.

Stopword matching may be performed by lookup or semantic matching. In an example, each candidate phrase 323 may be mapped to a vector representation and similarly each phrase in the stopword dictionary is also mapped to vector representation and a cosine similarity is measured between them.

Stopwords matching may be done based on embedding similarity of candidate phrase 323 with each of pre-built stop words.

Stopwords match 326 generates a stopwords match score for each candidate phrase 323 based on the similarity to the stopwords dictionary.

In some embodiments, other rules may be implemented by keywords extractor 300 such as filters for regular expressions, length, character type and the like, to omit certain candidate phrases 323 from consideration as keywords 342.

At block 328, different selection threshold values are determined for each candidate phrase 323 based on a source score, vocabulary match score and stopwords match score for the candidate phrase 323.

In some embodiments, a selection threshold value for a candidate phrase 323 may be based at least in part on a source score based on the source of the candidate phrase 323, such as meta tags, title tags, anchor tags, htags, or ptags.

Based on prior knowledge of sources for quality keywords, a source score may be based on the “quality” of the source. The quality of a source may be in descending order as between meta tags, title tags, anchor tags, htags, ptags, and correspond to a source score correlated to the quality of the source (with a higher source score attributed to a higher quality source, and a lower source score attributed to a lower quality source). As a result, lower selection threshold values may be used for good (or higher quality) sources, and vice versa.

The selection threshold value for each candidate phrase 323 can also be impacted by its vocabulary match score and its stopwords match score, reflecting whether it is found in vocabulary or stopwords lists, respectively. A higher vocabulary match score may result in a lower selection threshold value, and vice versa. A higher stopwords match score may result in a higher selection threshold value, and vice versa.

At block 332, visible sentences 333 are extracted from home and level two pages of website 101.

“Level two pages” can be defined as webpages that hyperlinked from home page of a website but still under the same domain name. For tealbook.com, tealbook.com/about/, tealbook.com/data-foundation/tealbook.com/contact/are all level two pages.

Visible sentences 333 may be extracted from website 101 to generate a document that reflects a presentation or a description of the company—what the company does, what the company's business purpose is, or any other suitable information describing the company. Such a document may be a snippet generated from extracted visible sentences.

Visible sentences 333 may also be classified as selected sentences 336 by sentence classifier 334, and if a candidate phrase 323 is well-represented in selected sentences 336, in an example, a similarity exceeds a threshold, the candidate phrase 323 is designated as a keyword 342 and otherwise discarded, as described in further detail below with reference to block 340.

Sentence classifier 334 is a suitable machine learning model, which may be trained offline, to classify visible sentences 333 of website 101 as selected sentences 336. Sentence classifier 334 may be trained as described below, with reference to the training pipeline.

Selected sentences 336 can also be a candidate pool of sentences for description and long description of the company.

At block 340, keyword extractor 300 evaluates whether the similarity of each candidate phrase 323 with selected sentences 336 exceeds a selection threshold, to determine how well the candidate phrase 323 matches with visible sentences.

To determine the similarity of a candidate phrase 323 and selected sentences 336, candidate phrase 323 and selected sentences 336 may be mapped to respective vector representations and cosine similarity measured between them.

In some embodiments, selection threshold values are hyperparameters of keyword extractor 300 that are selected based on data and prior knowledge, and may be tuned based on trial.

The hyperparameters can impact the quality and quantity of selected keywords 342, as when cosine similarity of candidate phrases 323 with selected sentences 336 exceeds these thresholds a candidate phrase 323 is considered to be keyword 342. Therefore, selecting the selection threshold values can be important, however, a back propagated signal may not be available to indicate the qualitative performance given a threshold value. In some embodiments, semi-supervised learning can be used in combination with company classifier 500 and similarity scorer 600 to evaluate which threshold values are best performing. In some embodiments, keyword extractor 300, company classifier 500 and similarity scorer 600 may be evaluated together in an iterative fashion cross-validating hyperparameters in each.

The cosine similarity can be compared to a selection threshold value, as discussed above. The selection threshold value for a candidate phrase 323 can vary based at least in part on the vocabulary match score, stopwords match score, and/or source of candidate phrase 323.

The threshold evaluation at block 340 can be a binary classification (selected or not selected). If the similarity exceeds the selection threshold for that candidate phrase 323, the candidate phrase 323, which can be a word or a phrase (i.e., more than one word or token), is designated as a keyword 342. If the similarity does not exceed the selection threshold, the candidate phrase 323 is discarded.

Keywords 342 identified by keyword extractor 300 can be used as input to matcher 400 as features to be matched.

Keywords 342 identified by keyword extractor 300 can also be used as input for company classifier 500, discussed in further detail below.

A training pipeline can be executed to train machine learning algorithms, form rules, build procedures and construct index files for keyword extractor 300.

A training pipeline can be configured to build components that help in extracting more signal text over noise text. Inference pipeline 320 may efficiently run such components together at scale to extract keywords from millions of websites.

In some embodiments, an objective of sentence classifier 334 is to filter out signal sentences from noise sentences of visible sentences 333.

In some embodiments, sentence classifier 334 can be implemented as an xgboost classifier trained on 3500 manually labelled sentences with following features ranging from grammatical cues to semantics (input to the xgboost classifier):
Number of “Bad Named Entities” present in the sentence. Bad Named Entities are entities which are classified as “TIME”, “DATE”, “MONEY”, “QUANTITY”.
Number of tokens in the sentence (favours long sentences over short).
Whether the “subject” of the sentence is either of {‘you’, ‘he’, ‘she’, ‘i’, ‘her’, ‘his’}, as they tend to talk about a person rather than the company.
Whether the “root” of the sentence is a Verb. As these type of sentences tend to be instructions such as “click here to know more” and noisy.
Whether there are any pre-defined stop words {‘please’, ‘below’, ‘cookie’} in the text.
Output probability of a first BERT classifier which is trained to distinguish sentences that look like they are originating from “contact” pages from the rest.
Output probability of a second BERT classifier which is trained to distinguish sentences that look like they are originating from “web form” pages from the rest.
Output probability of a third BERT classifier which is trained to distinguish sentences that look like they are originating from “careers” pages from the rest.
Output probability of a fourth BERT classifier which is trained to distinguish sentences that look like they are originating from “privacy policy” pages from the rest.
Output probability of a fifth BERT classifier which is trained to distinguish sentences that look like they are originating from “media” pages from the rest.
Output probability of a sixth BERT classifier which is trained to distinguish sentences that look like they are originating from “testimonials” pages from the rest.
Output probability of a seventh BERT classifier which is trained to distinguish sentences that look like they are originating from “team” pages from the rest.

Language features may be extracted, using a suitable library such as SPACY to identify named entities.

Sentence classifier 334 can include an ensemble of classifiers, in an example, URL classifiers such as the seven BERT classifiers referred to above. Each URL classifier can be trained and used to identify visible sentences 333 that are extracted from website 101 in a particular category, such as “contact”, “web form”, “careers”, “privacy policy”, “media”, “testimonials”, or “team”. In an example, a “contact” classifier can identify visible sentences 33 extracted from website 101 that are classified as coming from contact pages. Similarly, a “privacy policy” classifier can be used to identify sentences that discuss terms and conditions, policies, and the like. Each classifier is meant to focus on one particular category and discard other pages, the output of all the classifiers can then be input to another classifier, such as xgboost as described above.

The visible sentences 333 that may be relevant are those explaining products, solutions and/or services of a company. Visible sentences 333 such as from a careers page describing positions that are open, registration, a privacy policy, and the like, may be less relevant in extracting keywords from a website to characterize a company.

While it would be desirable to select sentences from products/solutions/services pages, it is not always straightforward to identify which web pages in a website such as website 101 can be treated as relating to products/solutions/services.

Searching for phrases such as “products”, “solutions”, or “services” in URL paths, may not be a reliable method as these concepts could be captured in phrases with numerous variants. It has been observed that when examining websites for URL paths with these phrases, less than 15% have URL paths with these phrases. For each of the URL classifiers, sentences pulled from the pages of URL paths with these phrases can be used as positive labelled training data. Negative labelled training data for each URL classifier can be based on categorizing known “bad” URLs into buckets based on different categories for each URL classifier type, such as “contact”, “web form”, “careers”, “privacy policy”, “media”, “testimonials”, or “team”.

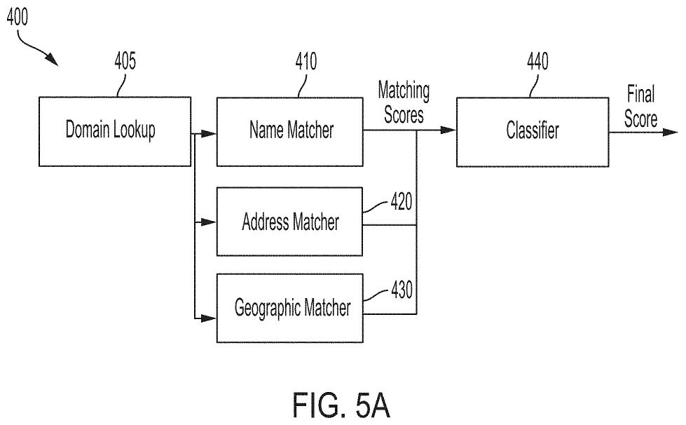

Sentence classifier 334 may include one or more types of URL classifiers. FIG. 4 illustrates a table 350 summarizing negative training data that can be obtained for each type of URL classifier in sentence classifier 334, based on a URL sub path used, according to an embodiment.

In use, URL classifiers may not rely on the URL path of pages of a website 101.

In some embodiments, all URL classifiers are combined into an ensemble in sentence classifier 334. Each URL classifier can be trained to distinguish sentences for its category, and the output probability of all the URL classifiers can be averaged.

When a visible sentence 333 is passed into sentence classifier 334, the output can be a probability or identification of whether the sentence relates to products and services. The visible sentence 333 is passed into each of the (in an example, 7) URL classifiers such as BERT classifiers. Output of the URL classifiers can be, in an example, a probability between 0 and 1 as to whether the sentence comes from that classifier's category, such as “contact”, “web form”, etc., or not. Output of the URL classifiers and the features identified above can then be passed into a decision tress such as an XGBoost classifier, to decide whether to include (select) the sentence or not to.

In some embodiments, performance of the URL classifiers has been characterized with each individual URL classifier of classifier 334 having an f1-score above 0.95, and the ensemble classifier 334 having an f1-score of 0.83.

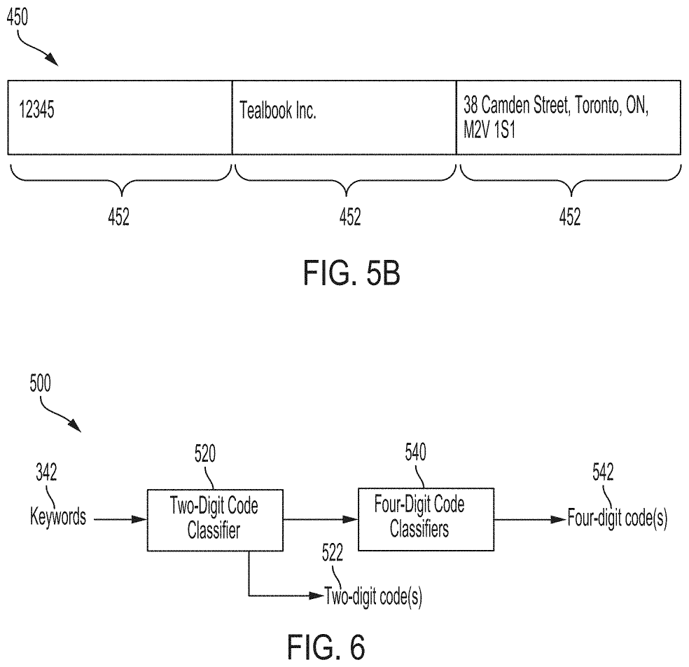

FIG. 5A is a schematic diagram of an implementation of a matcher 400, according to an embodiment, including a domain lookup 405 to identify candidate domains for a company, various features matchers such as a name matcher 410, an address matcher 420 and a geographic matcher 430 to generate matching scores against existing data records, and a classifier 440 to generate a final score for the likelihood a candidate domain is associated with a particular company.

Matcher 400 can be configured to associate features, in an example, a domain, to a company profile (implemented in an example as a data record) by matching information about that company such as extracted addresses and phone numbers from one or more candidate companies, which can be identified in an example by candidate domains.

Before associating features with a company, data may be extracted (e.g., name, address, phone, and the like) for a candidate domain using techniques for information extraction as disclosed herein.

In some embodiments, matcher 400 determines a matching score for how likely a particular feature (e.g., name, address, phone, etc.) from a candidate domain matches a company. Such features can be extracted using techniques disclosed herein, for example, a company name by company identifier 200 and keywords 342 from keyword extractor 300. A matching score for a name can be generated by a name matcher 410, a score for an address can be generated by an address matcher 420, and a score for a geographic location can be generated by a geographic matcher 430.

The matching scores can then be classified by classifier 440 to determine a final score, reflecting the likelihood that the candidate domain is associate with the company. If the final score is above a threshold, the candidate domain may be designated as a feature 452 to add to a data record 450 for that company, and other associated feature(s) 452 may also be added to the data record 450 for that company.

A data record 450 for a company, shown by way of example in FIG. 5B, can include features 452 of the company such as a unique identifier, a name of supplier and other features, URL, address, phone, and the like. Data records 450 for companies can be stored in a suitable database.

In some embodiments, matcher 400 can select a feature 452, such as a web domain, to identify a company and to be used as a common link between additional information or other features for that company. Thus, other features 452 can be matched to a company.

In an example, features 452 illustrated in FIG. 5B can be matched to a domain feature 452 “tealbook.com”, and that domain feature 452 used to identify the company within data.

To determine a domain feature 452, domain lookup 405 can extract candidate domain names for a company, based at least in part on one or more other known features 452 associated with the company, from one or more of a number of sources, such as:
Internal Lookup within internal data via:
   An Internal ID for the company
   DUNS
   Tax ID
   Name (with corroborating address or phone)
External Search sources
   BING Entity Search
   Google Places API search
Predicting the domain based on the company name feature (for example, from the name “Tealbook Inc.”, predicting the domain “tealbook.com”, “tealbookinc.com”, “tealbook.ca”, etc.).

In some cases, sources such as those identified above can return multiple candidates for a domain. Domain lookup 405 can thus identify candidate domains for a domain feature 452 for a company.

Candidate domains may be filtered out that do not match a certain amount of corroboration. Filtering may be done by way of a trained classifier 440 that examines different fuzzy matching scores based on features such as name(s) of the company, address(es), and phone number(s), for example, using name matcher 410, address matcher 420 and geographic matcher 430 described in further detail below.

In some embodiments, features can be extracted from website(s) of candidate domains, such as name, address, geography, and the like, which can be compared to an existing data record 450 to compare those features to those existing in the original data record 450.

For each candidate domain, name matcher 410, address matcher 420, and geographic matcher 430, generate matching scores for that candidate domain as described further below. Matches of the features can indicate an increased confidence that a candidate domain is an accurate domain feature 452 for the company.

Some or all of the matching techniques disclosed herein, performed by name matcher 410, address matcher 420, and/or geographic matcher 430, or other suitable matching, can be performed.

Name matcher 410 matches and scores company names extracted from a candidate domain website, in an example, names extracted using techniques disclosed herein, against existing or known name feature(s) 452 in an existing data record 450 for a company.

Company names can have a lot of variability and different names, for which it may be desirable to match well. The following examples show some common types of variability:
Tealbook Inc./Tealbook (Presence of legal terms)
Tealbook USA/Tealbook Canada (Different geographic suffixes)
Tealbook/Tealbook Enterprise Solutions (Extended names)
IBM/International Business Machines (Acronyms)
Ernst and Young/Ernst & Young (Ampersands)

The above examples of variability may also appear combined, such as “Tealbook Canada Inc.” vs. “Tealbook”, which combines the first two types of variability identified above.

Examples of pairs of names for which it may be desirable to match poorly, include:
Alpha Fire and Safety Systems/Beta Fire and Safety Systems
Boston Consulting Group/Boston Pizza

To aid with scoring, name matcher 410 can be configured to perform the one or more of the following:
Normalizing names to remove standard legal terms (e.g. Inc., Corp., GmBH, etc.) for some comparisons.
Capturing the uniqueness of a word (or ngrams) so while “Tealbook Solutions” and “Tealbook Enterprises” might be considered the same company owing to the relative uniqueness of “Tealbook”, a pair of names like “Apex Solutions” and “Apex Enterprises” would not be considered the same company, given how generic and common the word “Apex” is.
Removing certain confounding words, for example, in comparing “Boston Consulting Group” and “Boston Pizza”, removing the word “Boston” so the comparison is between “Consulting Group” and “Pizza”.
Examine the semantic content of the words to further find similarity or dissimilarity.

Name matcher 410 generates a name matching score 412 for a candidate domain, the name matching score 412 reflecting the similarity of names at the candidate domain website with the initial data record 450.

Address matcher 420 matches and scores company addresses extracted from a candidate domain website, in an example, addresses extracted using techniques disclosed herein, against existing or known address feature(s) 452 in an existing data record 450 for a company.

Similar to name matching, address matching also presents some challenges in being able to tolerate variations including the following:
Abbreviations (e.g. “St./Street” or “NY/New York”)
Partial addresses (maybe the street address or country is missing and only a city/province/state is available, or maybe there is no Unit or Suite number)
P.O. Box address instead of street address
Outright different addresses which may still be indicative of the same company (e.g., when company moves to a nearby location)

Addresses may be parsed into pieces, in an example, using pypostal (https://github.com/openvenues/pypostal), and the pieces compared to each other to obtain an aggregate address matching score 422 reflecting how well two addresses match each other.

In some embodiments, address matcher 420 uses geocoding to obtain more precise location data (e.g. latitude/longitude) to compare addresses as well.

Address matcher 420 generates an address matching score 422 for a candidate domain, the address matching score 422 reflecting the similarity of addresses at the candidate domain website with the initial data record 450.

Geographic matcher 430 matches and scores a geographic location based on geocoding associated with a phone number extracted from a candidate domain website, in an example, addresses extracted using techniques disclosed herein, against existing or known address feature(s) 452 in an existing data record 450 for a company.

In some embodiments, geographic matcher 430 matches and scores an address extracted from a candidate domain website again a geographic location determined based on geocoding associated with a phone number feature 452 in an existing data record 450 for a company.

Geocoding from a phone number may be performed by python-phonenumbers (https://github.com/daviddrysdale/python-phonenumbers) or other suitable technique, for example, using phone number to location data.

Geographic matcher 430 generates a geographic matching score 432 for a candidate domain, the geographic matching score 432 reflecting the similarity of geographic location data at the candidate domain website with the initial data record 450.

Classifier 440 receives as input matching scores for a candidate domain, such as name matching score 412, address matching score 422 and/or geographic matching score 432, and determines a final score for how likely the candidate domain matches a given company.

Matching scores 412, 422, 432, may be preprocessed, parsed, re-combined and compared in a suitable manner, and may also get enhanced or evolve with new iterations of classifier 440.

Matching scores can be classified by classifier 440 to determine a final score, reflecting the likelihood that the candidate domain is associate with the company. If the final score is above a threshold, the candidate domain may be designated as a feature 452 to add to a data record 450 for that company, and other associated feature(s) 452 may also be added to the data record 450 for that company.

In some embodiments, matcher 400 can use a nature of a candidate company (e.g. descriptions/keywords/etc.) to further determine a likely match when the company belongs to the same industry as the company record 450. In an example, it may be likely that a biopharma company client would do business with other biopharma companies so for a candidate that matches reasonably well on the name, address, and/or phone, if it further matches well on the industry in question, it increases the confidence in the match.

In an example use case for matcher 400, a list of companies such as suppliers may be provided, with information such as an internal ID for the supplier, the supplier's name, the supplier's address, phone numbers, email addresses, DUNS number and tax identifiers. Matcher 400 may match these suppliers to a master data record 450 of the supplier which may include additional information or features, such as quality or diversity certifications for the supplier, allowing for further insight and understanding of the suppliers.

Conveniently, embodiments of matcher 400 may account for variations that one might encounter when comparing data of features of a company.

Matcher 400 may correctly identify matches that are not immediately obvious, for example, when the name of a candidate differs substantially from the given supplier. This can happen for instance as a result of a merger or acquisition. If the new company maintained the old company's address/phone number so as to give a near perfect match on that corroborating data, then it is possible to still correctly identify the match.

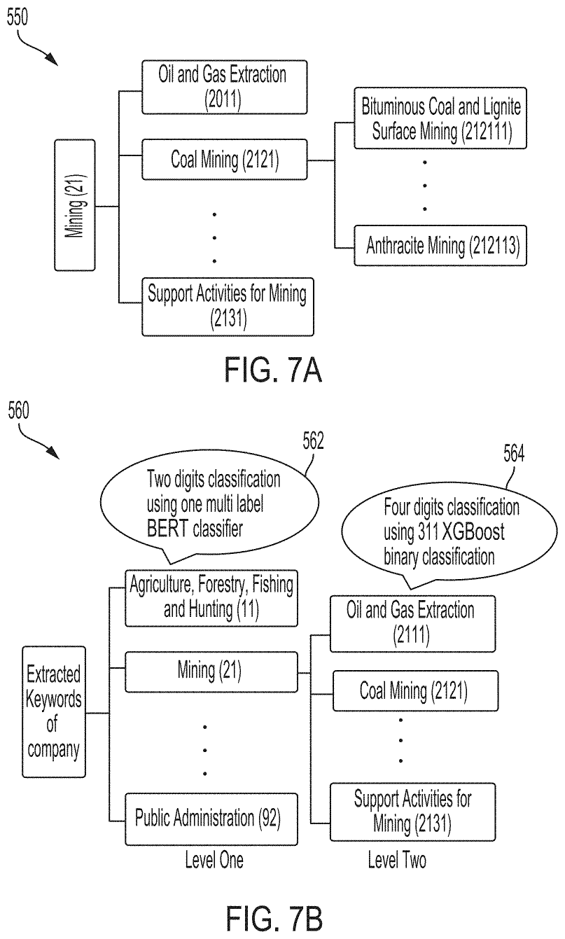

FIG. 6 is a schematic diagram of an implementation of company classifier 500, according to an embodiment. Company classifier 500 can be configured to predict classification codes or industry categories, such as industry classification codes, for companies. In an example, industry classification codes can be specified by the North American Industry Classification System (NAICS codes).

As shown in FIG. 6, classifier 500 can receive keywords 342 identified by keyword extractor 300 as input, and include a two-digit code classifier 520 and a four-digit code classifiers 540.

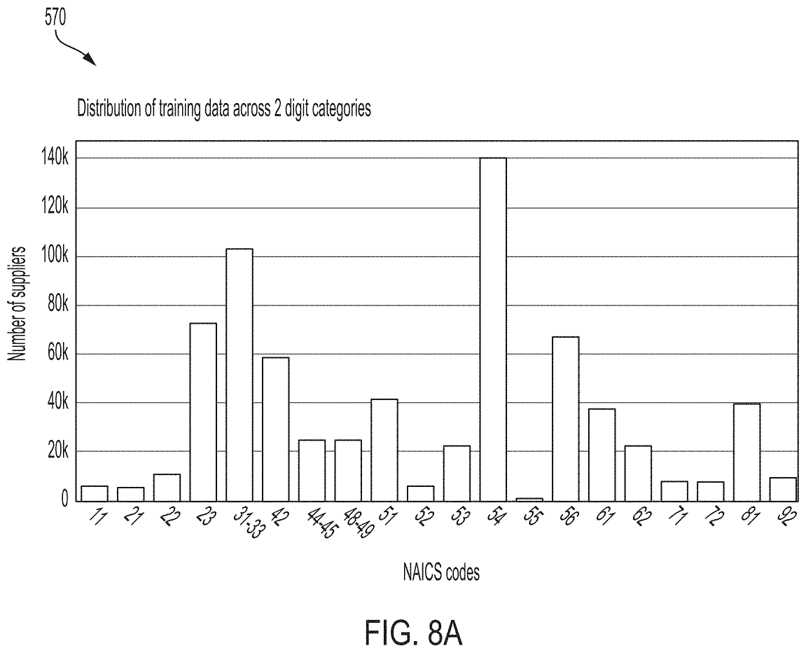

Company classifier 500 may be implemented as a multi-label hierarchical classifier. Company classifier 500 may be multi-label to allow for multiple codes to be attributed to each company. Company classifier 500 may be hierarchical to allow industry codes such as NAICS codes to follow multiple levels, for example, level one (two-digit codes), level two (four-digit codes), level three (six-digit codes), and the like. Each two-digit code can have multiple four-digit codes underneath it and similarly each four-digit code can have multiple six-digit codes under it. Level one of NAICS codes can represent sector and industry. A hierarchical structure 550 of a mining classification code, in an example, is illustrated in FIG. 7A.

In some embodiments, company classifier 500 can predict NAICS codes up to level two (four-digit codes). There are currently 311 such four-digit codes specified by NAICS. The architecture of company classifier 500 explores the hierarchical structures embedded in the codes, as detailed in FIG. 7B.

FIG. 7B illustrates an example hierarchy structure 560, and application of two-digit code classifier 520 at level one, and four-digit code classifiers 540 at level two.

Two-digit code classifier 520 can perform classification of two-digit industry codes or categories (such as NAICS) using, in an example, on multi-label BERT classifier.

Input to two-digit code classifier 520 can include keywords 342 associated with a particular website 101 by keyword extractor 300. One or more keywords 342 can be input to two-digit code classifier 520, in some embodiments, up to a maximum of 64 keywords 342.

Two-digit code classifier 520 can output at an output layer a categorical vector, in an example, a 20-dimensional vector (representing the 20 possible two-digit code categories) indicating the probability of the keywords 342 falling under one or more of the 20 categories (for example, in a range between 0 and 1). The outputs can be converted into representations of discrete categories of one or more two-digit code(s) 522 for keywords 342, as one or more two-digit code(s) for which the probability meets a threshold for that two-digit category, in an example, 80%.

A layer before the output layer can be a dense layer, a 128-dimensional layer having embeddings. These embeddings can be input for XGBoost classifiers of four-digit code classifiers 540, as well as similarity scorer 600.

Four-digit code classifiers 540 can perform classification of four-digit industry codes or categories (such as NAICS) using, in an example, 311 XGBoost binary classifiers, one classifier for each of the 311 four-digit codes.

In some embodiments, the classifiers of four-digit code classifiers 540, such as 311 XGBoost binary classifiers, can be binary, each outputting a probability (for example, between 0 and 1) of whether the keywords 342 are in that four-digit class or not. The outputs can be converted into representations of discrete categories of one or more four-digit code(s) 542 for keywords 342, as one or more four-digit code(s) for which the probability meets a threshold for that four-digit category, in an example, 80%.

In some embodiments, labeled training data (NAICS code data) can be used for training company classifier 500 (supervised), and transfer learning applied to similarity scorer 600.

Training data for company classifier 500 can be acquired by scraping various government registration databases (for e.g., sam.gov, smwbe.com, sba.gov, etc) which have supplier details that may include NAICS codes associated with them. This training data can be used to train two-digit code classifier 520 and four-digit code classifiers 540.

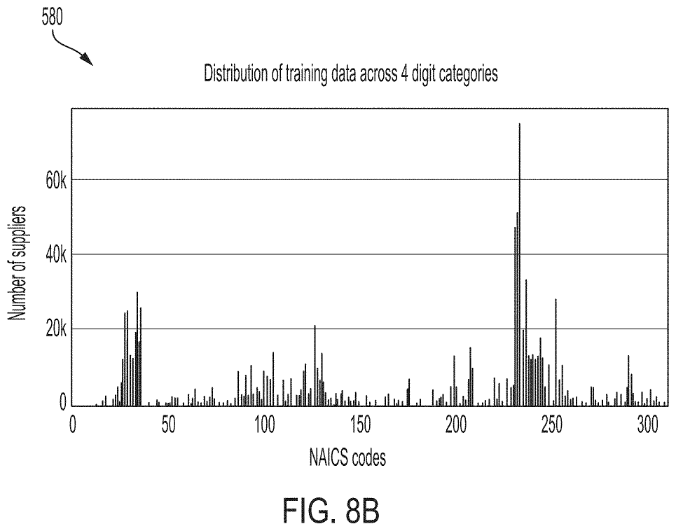

In an example, 330,000 supplier records have been acquired from government registration databases, though the distribution of these suppliers across the codes is uneven, making the dataset very imbalanced, as shown in the density plots 570 and 580 of FIG. 8A and FIG. 8B. Density plots 570 and 580 show, respectively, a distribution of training data across two-digit categories and a distribution of training data across four-digit categories. As can be seen in FIG. 8A and FIG. 8B, variations in training data may exist. Certain codes are more common, e.g., manufacturing, and training data can thus be imbalanced.

Imbalanced training data may result in trained classifiers that are biased towards overrepresented data, and it can be more difficult for classifiers to learn features of unrepresented labels.

Certain techniques may be implemented to address imbalanced training data, such as the final layer of the classifier being a sigmoid layer. Other techniques include up-sampling or down-sampling labels to highly represented data, or a loss function being a weighted loss function.

Training data may be erroneous, for example, because of outdated information about the company or as companies are incentivized to claim more NAICS codes than they can be attributed for. Upon manual examination of training data, in some examples it has been seen that around 40-50% of the training data for a particular NAICS code is incorrect.

For training two-digit code classifier 520, in an example, a pre-trained BERT model, even with errors in training data, two-digit code classifier 520 can be fine-tuned using techniques such as using a weighted sigmoid loss function in the final layer, where the weight of each two-digit code or category is inversely proportional to training size available. In some embodiments, the outputs of two-digit code classifier 520 for each company are 20 values corresponding to each two-digit category in the range of 0 to 1. The outputs can be converted into discrete categories by choosing individual category thresholds that provide at least certain amount of precision (in an example, 80%).

Threshold may be selected based on a validation data set, such that a threshold is selected that gives at least 80% precision. For each two-digit category, precision may be measured separately. In an example, a threshold may be initialized at zero, having 0% precision. The threshold may be slowly or iteratively increased until increases until 80% precision is reached, which can be selected as a threshold value to use.

Since noise in training data is also distributed across categories, in some embodiments, two-digit code classifier 520 treats the noise as white noise and may do a good job in learning features for individual category.

To fine-tune two-digit code classifier 520, a 128-node dense layer can be added with dropout value of 0.1 as a pre-final layer (with the final layer having 20 nodes corresponding to each category). The weights for the pre-final layer can be trained as part of fine-tuning the overall two-digit code classifier 520. The purpose of the 128-node pre-final layer is as values are used as supplier “embeddings” for downstream tasks—for example, four-digit NAICS code prediction by four-digit code classifiers 540, similarity scorer 600, or a semantic search.

For four-digit code prediction, one challenge is that the number of training samples may not be many for each code. Using one four digit classifier for all codes under a single two digit classifier could make it difficult to differentiate the nuances in language with few good examples. A challenge with obtaining training data from government databases is that there can be a great deal of overlap between four-digit categories, with companies designating themselves in multiple four-digit categories, reducing the utility as training data.

In an example, classifying a company into “General Freight Trucking” (4841) or “Specialized Freight Trucking” (4842) categories, can be challenging, since there are many companies who fall under both and there is overlap in keywords used. Furthermore, given a 40-50% rate of errors in data, prediction can be challenging.

Training data for four-digit code classifiers 540 can be generated representing four-digit codes by retaining good quality data and discarding low quality data. To achieve this, six-digit codes underneath four-digit codes may be used. NAICS (for example, Canada or US) specification describes example industries for each six-digit code, such as for “General Freight Trucking, Long-Distance, Truckload” (484121): “Bulk mail truck transportation, contract, long-distance (TL)”, “Container trucking services, long-distance (TL)”, “General freight trucking, long-distance, truckload (TL)”, “Motor freight carrier, general, long-distance, truckload (TL)”, “Trucking, general freight, long-distance, truckload (TL)”.

For each four-digit code, example industries can be scraped, for example, from naics.com, for all six-digit codes that fall under it, and combined into a data set. Various permutations of the combination of the example industries can be randomly sampled, where the number of random samples is equal to the size of training data available for the four-digit code. The example industries alone may not be suitable as training data for four-digit codes, since that data may be biased to the point that four-digit code classifiers 540 cannot model variances in keywords across company profiles. Thus, initial training data (for example, keywords from a website for companies with a particular four-digit code) can be augmented with example industries from the government database such as naics.com, and the size of data available for each four-digit code is doubled, and four-digit code classifiers 540 can be trained with augmented data of website language plus the six-digit NAICS specification and descriptions of example industries, or augmented data that has been filtered as described below.

Example industries extracted from 6-digit codes can impose “bias” in the training data. Text in the training data can be converted into embeddings using the 128-node pre-final dense layer of two-digit code classifier 520, and the 128 float values for a company act as a feature set in four-digit code prediction by four-digit code classifiers 540. A “biased” probability density function can be constructed and marked with the same four-digit code, using a kernel density estimator, which may help in modelling how training data distribution should look for each four-digit code. Since the density function is augmented with example industries, the density function may tend to score high for training samples which are closer in semantics to example industries.

The top 50% highly scored training samples by the density estimator of each four digit code may be used as actual training data, which may provide good quality samples, and the remaining badly-labelled samples can be discarded.

The positive labels for four-digit code classifiers 540 can be such filtered top 50% scored samples for that code and negative labels can be a random combination of all four-digit codes that are under same two digit code. For example, training one of the four-digit code classifiers 540, XGBoost binary classifier for 5615 code, the negative samples are from four-digit codes {5611, 5612, . . . , 5629}-{5615}. In some embodiments, there are equal number of samples for positive and negative labels to avoid class imbalance, and this is repeated for all 311 models of four-digit code classifiers 540.

In some embodiments, company classifier 500 operates in a cascading fashion, with a two-digit classification first performed using two-digit code classifier 520 such as a BERT classifier. After two-digit classification by two-digit code classifier 520, four-digit code classifiers 540 can be applied from a particular category identified by two-digit code classifier 520. For example, if two-digit code classifier 520 identifies a two-digit code 522 as “Mining”, there are twenty different four-digit codes under “Mining”, and the twenty (out of 311) XGBoost binary classifiers of four-digit code classifiers 540 associated with each of those twenty four-digit codes will perform classification, using embeddings from the two-digit BERT classifier.

It will be appreciated that in some embodiments, company classifier 500 can predict other digit codes, or other industry classifications.

Outputs of classifier 500, including two-digit code 522 and four-digit code 542, can be used by similarity scorer 600 in identifying similar companies. Embeddings generated by two-digit code classifier 520 can also serves as input for similarity scorer 600.

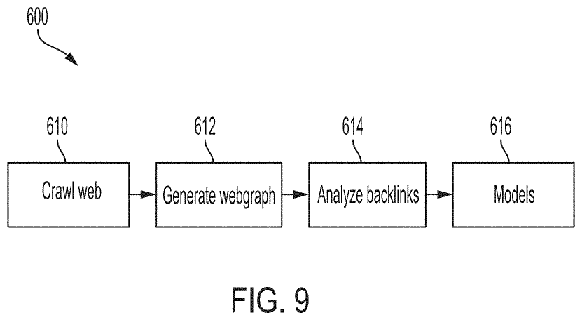

FIG. 9 illustrates a schematic of similarity scorer 600, according to an embodiment, and can include components to crawl web 610, generate a webgraph 612, analyze backlinks 614, and features from the analysis input to models 616. Similarity scorer 600 can be configured to identity similar companies, such as suppliers.

Every month, Common Crawl releases an archive of a portion of internet on their website https://commoncrawl.org/the-data/get-started/. The monthly data can be a snapshot of HTML pages along with metadata about each HTML page organized into WARC files. A typical crawl dump for a month can contain approximately 60,000 WARC files. Each WARC file can include a list of WARC records grouped together, where a WARC record has following attributes: warc record: <url, header, html>; url: the URL where the HTML page is crawled from; header: contains metadata related to the page such as crawl time, size, crawl date, content language, etc; html: HTML content of the webpage being crawled, which can be parsed for hyperlinks appearing in it.

Similarity scorer 600 at block 610 can crawl the word wide web, for example, by accessing WARC files from Common Crawl, and the WARC files can be processed to generate two output CSV files.

The first output CSV file can include the following columns: source_url: URL where the HTML is crawled from; domain_name: domain name of the hyperlink appearing in the HTML page; anchor text: anchor text of the corresponding hyperlink; surround_text: text appearing around the hyperlink up to parent level. In some embodiments, a source_url may have multiple hyperlinks appearing in it, and hence multiple domain_name tags associated with it.

The second output CSV file can include the following columns: source_url: URL where the HTML is crawled from; email_addr: email address appearing in HTML page; surround_text: text appearing around the hyperlink up to grandparent level.

The first output CSV file may be used in identifying similar companies. The second output CSV file may be used in finding company contacts.

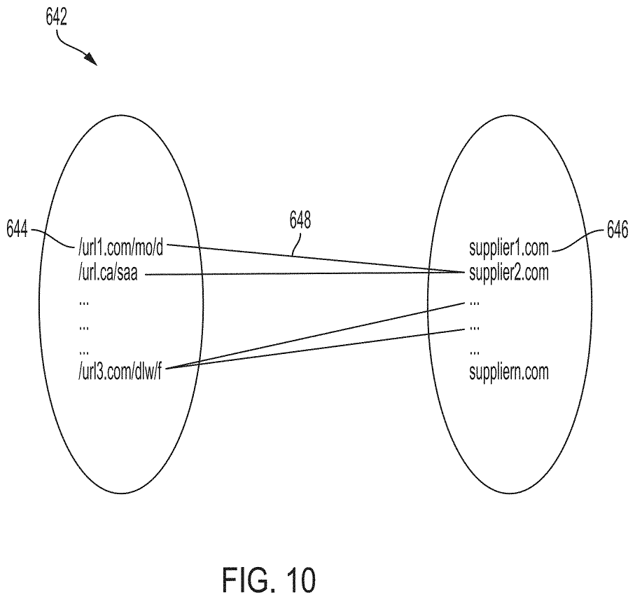

At block 612, similarity scorer 600 generates a webgraph 642 based at least in part on the first output CSV file. In some embodiments, webgraph 642 can be embodied as a bipartite graph, where source_urls are mapped into domain_names, as shown by way of example in FIG. 10.

As shown in FIG. 10, webgraph 642 can include nodes (URLs 644 and domain names 646) and relationships 648 (links between URLs and domain names) represented as an edge between the nodes. URLs 644 are those whose HTML pages have been crawled, for example, in WARC files. Domain names 646 are domain names of companies. A relationship can be established between a URL 644 (ux) and a domain name 646 (dx) when dx appears in the HTML page crawled with ux. In some embodiments, nodes and relationships can be loaded into a graph database. In some embodiments, the graph database can be a Neo4j graph database, that may be public and free and easy to query, or other suitable graph database.

After crawling a data dump of one month, 1.19 billion total nodes can result, of which 2.5 million nodes are domain names that belong existing companies recorded, such as in data store 110. Therefore about 62% of the existing companies have backlinks information, which may be designated as the most “important” companies. An example graph can have a total of 2.8 billion relationships, with each URL pointing to an average of two to three domains.

Given a webgraph 642 of a company's domain relationships, a graph database can be queried for information on which companies share backlinks with the company of interest, which can be iterated over all companies.

Out of a list of all other companies that share backlinks with a particular company, not all of them may be considered as similar.

In an example, company domains that share backlinks with tealbook.com can include: [‘linkedin.com’, ‘artofprocurement.com’, ‘procurious.com’, ‘buyersmeetingpoint.com’, ‘cbre.ca’, ‘typeform.com’, ‘cbreforward.com’, ‘palambridge.com’, ‘bdc.ca’, ‘formatherapeutics.com’, ‘thehackettgroup.com’, ‘ariba.com’, ‘wbresearch.com’, ‘matchbookinc.com’, ‘grandvcp.com’, ‘theartofservice.com’, ‘apple.com’, ‘supplychainbrain.com’, ‘procurementleaders.com’, ‘sievo.com’, ‘scoutbee.com’, ‘grubhub.com’, ‘ivalua.com’, ‘celonis.com’, ‘insightsourcing.com’, ‘basware.com’, ‘bain.com’, ‘gep.com’, ‘spendmatters.com’, ‘proximagroup.com’, ‘cips.org’, ‘waxdigital.com’, ‘workday.com’, ‘marsiaf.com’, ‘plum.io’, ‘studio98.com’, ‘bolderbiopath.com’, ‘scienceexchange.com’, ‘scientist.com’, ‘vanderbilt.edu’, ‘cmu.edu’, ‘fbi.gov’, ‘sedarasecurity.com’, ‘unc.edu’, ‘aujas.com’, ‘netlogx.com’, ‘phoenix.gov’, ‘information-management.com’, ‘nii.ac.jp’, ‘villanova.edu’, ‘marsdd.com’]

Review of the list above reveals domains for companies that are in the procurement space, such as ivalua.com, scoutbee.com, thehackettgroup.com, ariba.com, matchbookinc.com. However, the list also includes domains for companies that are in different dimensions that do not relate to similar product/solution offerings such as cbre.ca, bdc.ca, plum.io. There are also domains present such as linkedin.com, apple.com, fbi.gov which appear in the backlinks lists of almost every other company.

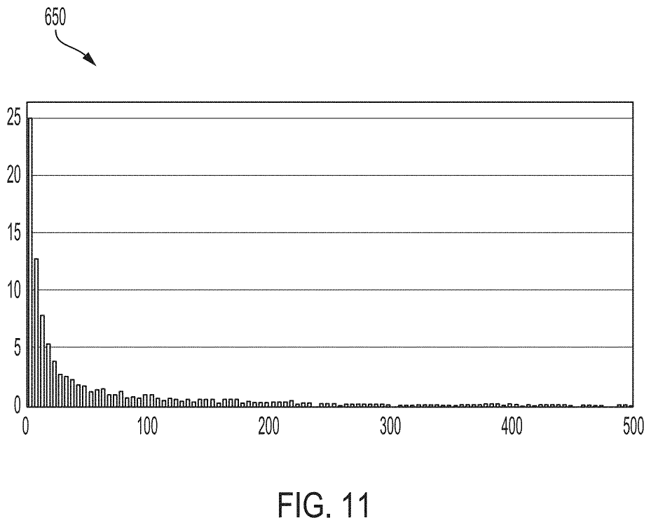

In the example above, the distribution of number companies, such as suppliers, that share backlinks highly varies, as shown in distribution plot 650 FIG. 11.

Thus, it may be desirable to analyze other signals to identify similar companies from the companies that share backlinks.

For a pair of companies (company A, company B) that share backlinks, the following features/characteristics can be determined to identify whether company A is similar to company B:
Number of shared backlinks between suppliers
Ingress degree A—number of backlinks pointing to company A. A higher ingress may indicate a larger company.
Ingress degree B—number of backlinks pointing to company B. A higher ingress may indicate a larger company.
Semantic Distance—Cosine distance (semantic distance) between the embeddings of company A and company B, where the embeddings are obtained from the pre-final 128-node dense layer of two-digit code classifier 520
Predicting company-level classification codes using company classifier 500
Two digit NAICS codes overlap—Normalized number of two digit NAICS codes (determined, in an example, by two-digit code classifier 520) common between backlinks of company A and company B
Four digit NAICS codes overlap—Normalized number of four digit NAICS codes (determined, in an example, by four-digit code classifier 540) common between backlinks of company A and company B

In the absence of any training data about similar suppliers, training labels may be generated by using heuristic rules on the computed features listed above.

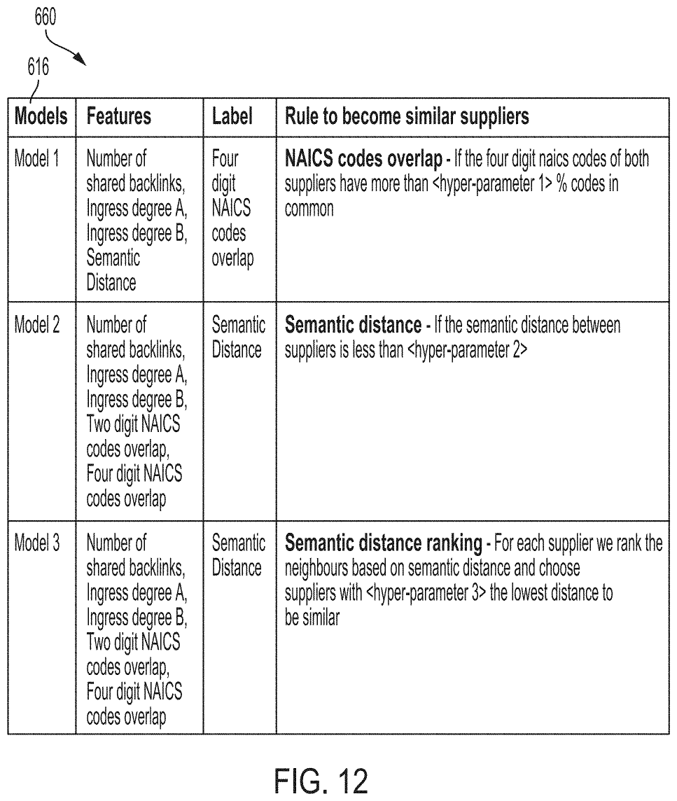

FIG. 12 illustrates features, labels, and rules of example models 616, such as “Model 1”, “Model 2” and “Model 3”.

For features such as those listed above, as shown by way of example table 660 in FIG. 12, one feature can be designated as a label with a threshold (rule to become “similar suppliers”), if met setting a value to one, otherwise zero, and the other features remain as “features”, as shown.

In the example of “Model 1” illustrated in FIG. 12, a label is used based on four-digit NAICS overlap between companies A and B. For companies A and B, if number of four-digit codes overlap by at least 30% (where 30% is “hyper-parameter 1”), it means they are similar. These labels are attained, and the remaining features used to train Model 1. For each company, labels may be global. For example, company A can have backlinks with 100 other companies and company B can have backlinks with 50 other suppliers, and labels are decided globally as between all suppliers.

Similarly, in the example of “Model 2” illustrated in FIG. 12, semantic distance is a label, with a threshold of semantic distance between embeddings of company A and company B obtained from the pre-final 128 node dense layer of two-digit code classifier 520. For each company, labels may be global.

In the example of “Model 3” illustrated in FIG. 12, semantic distance is localized, namely, the label is decided based on localized semantic distance. For example, for company A sharing backlinks with 100 other suppliers, semantic distance is considered as between all of them. Instead of threshold based on value, threshold is based on percentile that are similar for top closest semantic distance. This can be based on observing some backlinks and seeing how often they are similar.

Hyperparameters (such as “hyper-parameter 1”, “hyper-parameter 2”, and “hyper-parameter 3” of models 616, “Model 1”, “Model 2”, and “Model 3”, respectively, as shown in FIG. 12) can be tuned by examining the false positives and negatives predicted by the models. In some embodiments, false positives and negatives of the models are not really wrong, but are marked wrong because the rule bootstrapped the labels with does not handle that case.

Once trained, all features (such as those listed above) can be input for each of the models 616.

In some embodiments, one or more models 616 are XGBoost decision trees.

The probability outputs of the models 616 for each pair of companies can be ensembled, and a pair of companies designated as “similar” when the final probability crosses a threshold. In some embodiments, in the ensemble process more importance to suppliers that appear together in HTML page.

Each model 616 can output a probability of company A and B being similar. All of the probability outputs from each of Model 1, Model 2 and Model 3 can be combined, and averaged, and company A and B may be designated as “similar” if the averaged probability value meets a threshold value or not.

In some embodiments, the threshold value may be modified based at least in part on other company similarities. For example, given a determined similarity between company A and B, for company C, if company B and C have overlapping backlink URLs, since a similarity between company A and company B has been previously determined, a threshold value for company C being similar to company A may be lowered.

Thus, if a company A is identified to be similar to company B after performing similarity scorer 600 described above, and company C, A appear in the same webpage then there is increased chances of company C to be picked as similar supplier for B, which can be reflected by reducing the final threshold required to pair company C and A as “similar”. By establishing company A is similar to company B, there is more confidence on the context of webpage that company A appears in. Therefore, there are higher chances other companies in same webpage share that context of similarity.

In some embodiments, when two web domains of companies of interest appear together, for example, on a webpage of the same backlink URL, there may be some surrounding text to it. The surrounding text, for example, discussing a merger or acquisition, may be used by similarity scorer 600 to determine a similarity between companies.

In some embodiments, similarity scorer 600 may be embodied using k-nearest neighbours (KNN) to identify similarity between companies. Each company may have keywords 342 and long description determined by keyword extractor 400. Using keywords 342 and long description, along with embeddings from the pre-final 128-node dense layer of two-digit code classifier 520, embedding can be generated for each company mapped into embedding space. KNN clustering can be applied to identify similar companies.

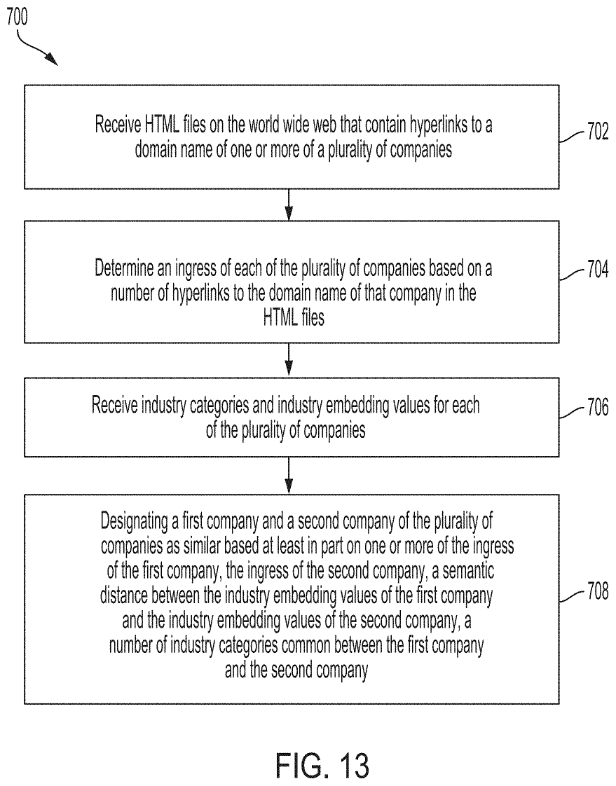

FIG. 13 illustrates an embodiment of a method 700 for profiling companies. The steps are provided for illustrative purposes. Variations of the steps, omission or substitution of various steps, or additional steps may be considered. It should be understood that one or more of the blocks may be performed in a different sequence or in an interleaved or iterative manner.

At block 702, similarity scorer 600 receives HTML files on the world wide web that contain hyperlinks to a domain name of one or more of the plurality of companies.

At block 704, similarity scorer 600 determines an ingress of each of the plurality of companies based on a number of hyperlinks to the domain name of that company in the HTML files.

In an embodiment, similarity scorer 600 may determine the ingress of one or more of the companies using a webgraph. For example, similarity score 600 may (i) identify URLs of HTML files on the world wide web that contain hyperlinks to a domain name of each of the companies, (ii) generate a webgraph linking the URLs with the domain name of one of the companies when the domain name of that one of the companies appears in the HMTL file of the URL, (iii) determine a number of shared backlinks between the companies based on a number of links to a same URL of the URLs in the webgraph as between the domain names of the companies, and (iv) determine an ingress of each of the companies based on a number of links to the domain name of that company in the webgraph.

At block 706, similarity scorer 600 receives industry categories and industry embedding values for each of the companies.

In some embodiments, the industry categories comprise two-digit industry categories, such as two-digit codes 522, and four-digit industry categories, such as four-digit codes 542.

In some embodiments, the industry categories comprise two-digit industry categories and four-digit industry categories, and for each of the companies are determined by company classifier 500: receiving keywords extracted from a website associated with the company; inputting the keywords to a two-digit category classifier such as two-digit code classifier 520, the two-digit category classifier including a pre-final dense layer for generating industry embedding values; classifying, at an output layer of the two-digit category classifier, the probability of the keywords being in one or more two-digit industry categories; identifying two-digit industry categories for which the probability meets a threshold; inputting the industry embedding values to a plurality of four-digit category classifiers, such as four-digit code classifier 540, each of the four-digit category classifiers a binary classifier for a four-digit industry category; and for each of the four-digit category classifiers, classifying the probability of the keywords being in that four-digit industry category.

In some embodiments, the two-digit code classifier is a multi-label BERT classifier.

In some embodiments, the four-digit code classifiers comprise XGBoost binary classifiers.

In some embodiments, keywords, such as keywords 342, are extracted from the website by keyword extractor 300: extracting visible sentences, such as visible sentences 333, from the website; classifying the visible sentences as selected sentences; extracting candidate phrases, such as candidate phrases 323, from the website; and for each of the candidate phrases: matching the candidate phrase to a vocabulary dictionary to generate a vocabulary score; matching the candidate phrase to a stopwords dictionary to generate a stopwords score; selecting a similarity threshold value for the candidate phrase based at least in part on a source of the candidate phrase, the vocabulary score and the stopwords score; and comparing the candidate phrase to the selected visible sentences to determine a similarity value, and when the similarity value is above the threshold similarity value, designating the candidate phrase as one or more of the keywords.

In some embodiments, the candidate phrases are noun phrases.

In some embodiments, the candidate phrases are extracted from metadata of the website.

In some embodiments, the candidate phrases are extracted from one or more of htags, meta tags, ptags and title tags of the website.

At block 708, similarity scorer 600 designates a first company and a second company of the plurality of companies as similar based at least in part on one or more of the ingress of the first company, the ingress of the second company, a semantic distance between the industry embedding values of the first company and the industry embedding values of the second company, a number of industry categories common between the first company and the second company.

In some embodiments, the first company and the second company are designated as similar based at least in part on a percentage of the number of common four-digit industry categories as compared to a total number of four-digit industry categories associated with the first company and the second company.

In some embodiments, first company and the second company are designated as similar based at least in part on a localized semantic distance between the number of shared backlinks, the ingress of the first company, the ingress of the second company, and the number industry categories common between the first company and the second company.

In some embodiments, the first company and the second company are designated as similar when the localized semantic distance is less than a predefined hyperparameter value.

In some embodiments, similarity scorer 600 designates a first company and a second company of the plurality of companies as similar using a graph-based data structure such as a knowledge graph. For example, similarity scorer 600 may construct a knowledge graph to encode descriptions of entities (e.g., companies, industry groups, government entities, etc.), the features/characteristics of such entities, and relationships with other entities.

Various information regarding features/characteristics that may be obtained by company identifier 200, keyword extractor 300, matcher 400, and company classifier 500 may be used in the construction of the knowledge graph. For example, such information may include, an ingress, a two-digit NAICS code, a four digit NAICS code, labels, keywords, or the like. Similarly, various information regarding the relationship between entities that may be obtained by company identifier 200, keyword extractor 300, matcher 400, and company classifier 500 may be used in the construction of the knowledge graph. Such information may, for example, include a count of shared backlinks with another company.

After a knowledge graph has been constructed, similarity scorer 600 may generate an embedding representation of the knowledge graph, whereby encoded information is transformed into embedding vectors. A conventional machine learning methodology for classification or clustering is applied to the embedding vectors to identify similar companies.

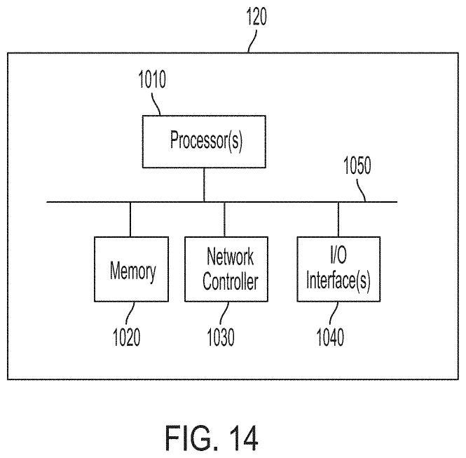

System 100, in particular, one or more of company identifier 200, keyword extractor 300, matcher 400, company classifier 500, similarity scorer 600, and data store 110, may be implemented as software and/or hardware, for example, in a computing device 120 as illustrated in FIG. 14. Method 700, and components thereof, may be performed by software and/or hardware of a computing device such as computing device 120.

As illustrated, computing device 120 includes one or more processor(s) 1010, memory 1020, a network controller 1030, and one or more I/O interfaces 1040 in communication over bus 1050.

Processor(s) 1010 may be one or more Intel x86, Intel x64, AMD x86-64, PowerPC, ARM processors or the like.

Memory 1020 may include random-access memory, read-only memory, or persistent storage such as a hard disk, a solid-state drive or the like. Read-only memory or persistent storage is a computer-readable medium. A computer-readable medium may be organized using a file system, controlled and administered by an operating system governing overall operation of the computing device.

Network controller 1030 serves as a communication device to interconnect the computing device with one or more computer networks such as, for example, a local area network (LAN) or the Internet.

One or more I/O interfaces 1040 may serve to interconnect the computing device with peripheral devices, such as for example, keyboards, mice, video displays, and the like. Such peripheral devices may include a display of device 120. Optionally, network controller 1030 may be accessed via the one or more I/O interfaces.

Software instructions are executed by processor(s) 1010 from a computer-readable medium. For example, software may be loaded into random-access memory from persistent storage of memory 1020 or from one or more devices via I/O interfaces 1040 for execution by one or more processors 1010. As another example, software may be loaded and executed by one or more processors 1010 directly from read-only memory.

Example software components and data stored within memory 1020 of computing device 120 may include software to perform data profiling, as described herein, and operating system (OS) software allowing for basic communication and application operations related to computing device 120.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A computer-implemented method for profiling a plurality of companies, the method comprising:
receiving HTML files on the world wide web that contain hyperlinks to a domain name of one or more of the plurality of companies;
determining an ingress of each of the plurality of companies based on a number of hyperlinks to the domain name of that company in the HTML files;
receiving industry categories and industry embedding values for each of the plurality of companies; and
designating a first company and a second company of the plurality of companies as similar based at least in part on one or more of the ingress of the first company, the ingress of the second company, a semantic distance between the industry embedding values of the first company and the industry embedding values of the second company, and a number of industry categories common between the first company and the second company.

2. The method of claim 1, further comprising identifying URLs of the HTML files.

3. The method of claim 2, further comprising generating a webgraph linking the URLs with the domains.

4. The method of claim 3, further comprising determining a number of shared backlinks between the first company and the second company based on the webgraph.

5. The method of claim 3, wherein the ingress is determined using the webgraph.

6. The method of claim 1, wherein the industry categories comprise two-digit industry categories and four-digit industry categories.

7. The method of claim 6, wherein the first company and the second company are designated as similar based at least in part on a percentage of the number of common four-digit industry categories as compared to a total number of four-digit industry categories associated with the first company and the second company.

8. The method of claim 1, wherein the first company and the second company are designated as similar based at least in part on a localized semantic distance between the number of shared backlinks, the ingress of the first company, the ingress of the second company, and the number industry categories common between the first company and the second company.

9. The method of claim 8, wherein the first company and the second company are designated as similar when the localized semantic distance is less than a predefined hyperparameter value.

10. The method of claim 1, wherein the industry categories comprise two-digit industry categories and four-digit industry categories, and for each of the companies are determined by:
receiving keywords extracted from a website associated with the company;
inputting the keywords to a two-digit category classifier, the two-digit category classifier including a pre-final dense layer for generating industry embedding values;
classifying, at an output layer of the two-digit category classifier, the probability of the keywords being in one or more two-digit industry categories;
identifying two-digit industry categories for which the probability meets a threshold;
inputting the industry embedding values to a plurality of four-digit category classifiers, each of the four-digit category classifiers a binary classifier for a four-digit industry category; and
for each of the four-digit category classifiers, classifying the probability of the keywords being in that four-digit industry category.

11. The method of claim 10, wherein the two-digit code classifier is a multi-label BERT classifier.

12. The method of claim 10, wherein the four-digit code classifiers comprise XGBoost binary classifiers.

13. The method of claim 1, wherein the keywords are extracted from the website by:
extracting visible sentences from the website;
classifying the visible sentences as selected sentences;
extracting candidate phrases from the website; and
for each of the candidate phrases:
matching the candidate phrase to a vocabulary dictionary to generate a vocabulary score;
matching the candidate phrase to a stopwords dictionary to generate a stopwords score;
selecting a similarity threshold value for the candidate phrase based at least in part on a source of the candidate phrase, the vocabulary score and the stopwords score; and
comparing the candidate phrase to the selected visible sentences to determine a similarity value, and when the similarity value is above the threshold similarity value, designating the candidate phrase as one or more of the keywords.

14. The method of claim 13, wherein the candidate phrases are noun phrases.

15. The method of claim 13, wherein the candidate phrases are extracted from metadata of the website.

16. The method of claim 15, wherein the candidate phrases are extracted from one or more of htags, meta tags, ptags and title tags of the website.

17. The method of claim 1, further comprising constructing a knowledge graph and generating a knowledge graph embedding.

18. A computer-implemented system for profiling a plurality of companies, the system comprising:
at least one processor;
memory in communication with the at least one processor;
software code stored in the memory, which when executed at the at least one processor causes the system to:
receive HTML files on the world wide web that contain hyperlinks to a domain name of one or more of the plurality of companies;
determine an ingress of each of the plurality of companies based on a number of hyperlinks to the domain name of that company in the HTML files;
receive industry categories and industry embedding values for each of the plurality of companies; and
designate a first company and a second company of the plurality of companies as similar based at least in part on one or more of the ingress of the first company, the ingress of the second company, a semantic distance between the industry embedding values of the first company and the industry embedding values of the second company, and a number of industry categories common between the first company and the second company.

19. A non-transitory computer-readable medium having stored thereon machine interpretable instructions which, when executed by a processor, cause the processor to perform a computer-implemented method for profiling a plurality of companies, the method comprising:
receiving HTML files on the world wide web that contain hyperlinks to a domain name of one or more of the plurality of companies;
determining an ingress of each of the plurality of companies based on a number of hyperlinks to the domain name of that company in the HTML files;
receiving industry categories and industry embedding values for each of the plurality of companies; and
designating a first company and a second company of the plurality of companies as similar based at least in part on one or more of the ingress of the first company, the ingress of the second company, a semantic distance between the industry embedding values of the first company and the industry embedding values of the second company, and a number of industry categories common between the first company and the second company.
